(19) United States
(12) Patent Application Publication
(10) Pub. No.: US 2019/0126081 A1
(43) Pub. Date: May 2, 2019

(54) STABLE WILDLAND FIRE ENGINE SYSTEM

(71) Applicants: Chad Oestreich, Arlington, TX (US); Dilon Oestreich, Arlington, TX (US)

(72) Inventors: Chad Oestreich, Arlington, TX (US); Dilon Oestreich, Arlington, TX (US)

(21) Appl. No.: 16/175,716

(22) Filed: Oct. 30, 2018

Related U.S. Application Data
(60) Provisional application No. 62/578,777, filed on Oct. 30, 2017.

(51) Int. Cl. A62C 27/00

(52) U.S. Cl. CPC A62C 27/00

(57) ABSTRACT

A stable wildland fire engine maintains a low center of gravity by placing water tanks lower than the frame. The water tanks are located inside or between the frame so that some portion of the stored water is lower than then top of the frame. The engine also has storage compartments that are located inside or between the frame.

### BACKGROUND

### 1. Field of the Invention

The present invention relates generally to automobiles, and more specifically, to a stable wildland fire engine system for carrying tools and providing capabilities specific to firefighting in a safe and efficient platform.

### 2. Description of Related Art

Automobiles are well known in the art and are effective means to transport people or equipment from one place to another. For example, FIG. 1 depicts a conventional wildland fire engine system 101 having a cab 105 and a work platform 107 rigidly attached to a frame 103. A water tank 109 is attached to the top the work platform 107. During use, tools and equipment are stored on the platform 107 and the engine 101 is driven to the work site where the water, people and tools preform a firefighting task.

One of the problems commonly associated with wildland fire engine 101 is its limited efficiency. For example, water is a common tool used in firefighting. Carrying large amounts of water above the frame 103 raises the center of gravity of the engine 101 reducing its all-terrain performance and increasing its roll over risk.

Accordingly, although great strides have been made in the area of wildland fire engines 101, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a cross-sectional side view of a common wildland fire engine system;

FIG. 2 is a cross-sectional side view of a stable wildland fire engine system in accordance with a preferred embodiment of the present application;

FIG. 3 is a top view of an alternative configuration of the system of FIG. 2;

FIG. 4 is a top view of an alternative configuration of the system of FIG. 2;

FIG. 5 is a top view of an alternative configuration of the system of FIG. 2;

FIG. 6 is a perspective view of an alternative configuration of the water tank of FIG. 2; and

FIG. 7 is a flowchart of the preferred method of manufacture of the system of FIG. 2.

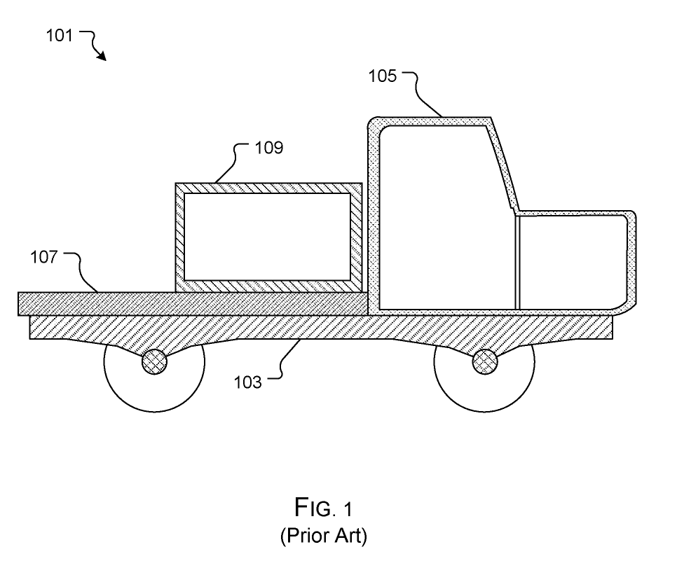

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional wildland fire engine systems. Specifically, the invention of the present application enables the storage of water and other equipment in a manner that preserves the driving capabilities of the Y by not raising its center of gravity. In addition, the invention preserves space above the frame or a working deck on the frame for other tools. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

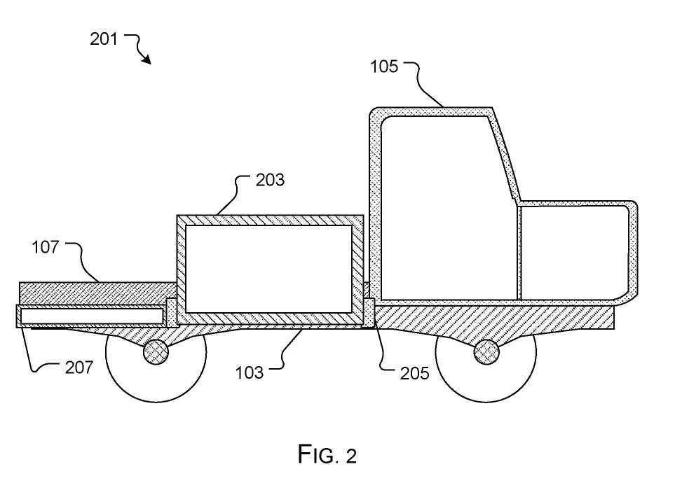

Referring now to the drawings wherein like reference characters identify corresponding or similar elements throughout the several views, FIG. 2 depicts a side view of a stable wildland fire engine system in accordance with a preferred embodiment of the present application. It will be appreciated that system 201 overcomes one or more of the above-listed problems commonly associated with conventional wildland fire engine systems.

In the contemplated embodiment, system 201 includes a water tank 203 attached to support member 205 and configures so that the tank 203 rests in between or below the frame 103 or work platform 107. Engine 201 also includes storage compartment 207 attached to support member 205 below the top of the frame 103. While a tank is noted any compartment or space to hold water or other fluids is contemplated.

It should be appreciated that one of the unique features believed characteristic of the present application is that some portion of water tank 203 is located below the frame 103. This configuration reduces the impact on the center of gravity caused by having a water tank 203 above the frame 103 or work platform 107.

Another unique feature believed characteristic of the present application is that storage compartments 207 allow tools or such equipment to be located as low as possible on engine 201.

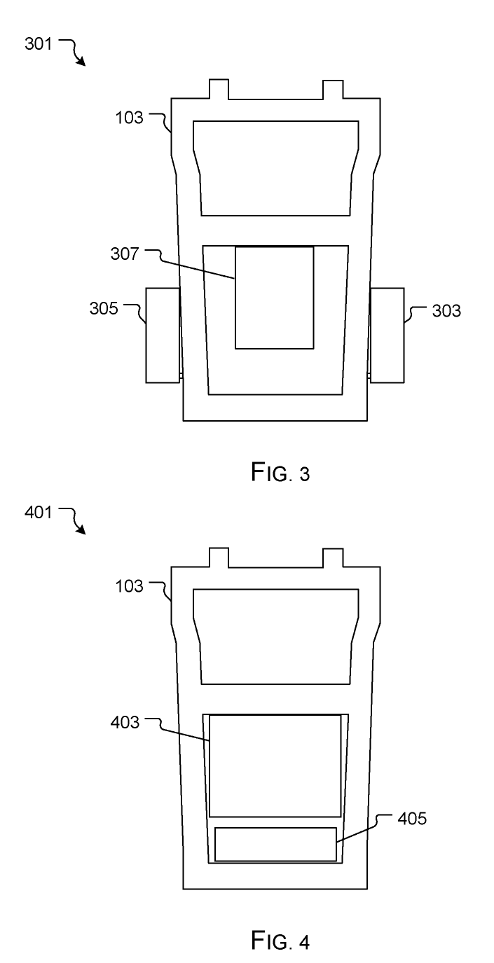

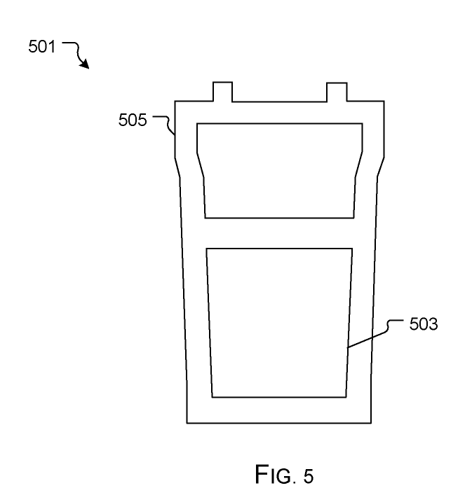

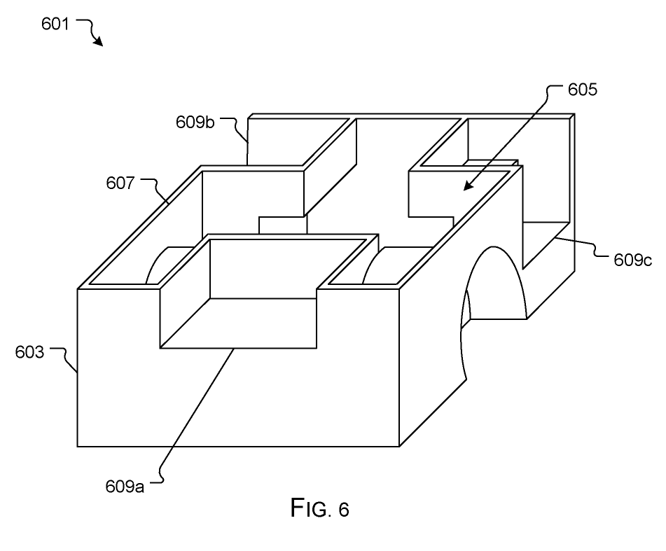

Referring now to FIGS. 3, 4 and 5 alternative configurations of the water tank 203 of FIG. 2 are depicted. Embodiment 301 having water tanks 303 and 305 located outside the frame 103 with water tank 307 located inside the frame 103.

Embodiment 401 having water tanks 403 and 405 located inside the frame 103. Embodiment 501 having water tank 503 integrated with frame 505. It will be understood and appreciated that having the frame 505 either pass through or form water tank 503 enables a lower center of gravity.

While embodiments 301, 401, and 501 depict water tanks it is also contemplated that storage comparts could replace the water tanks and not deviate from the intent of this disclosure. It will be understood that water is a common tool in firefighting and that in this way water tanks are tool boxes in their nature.

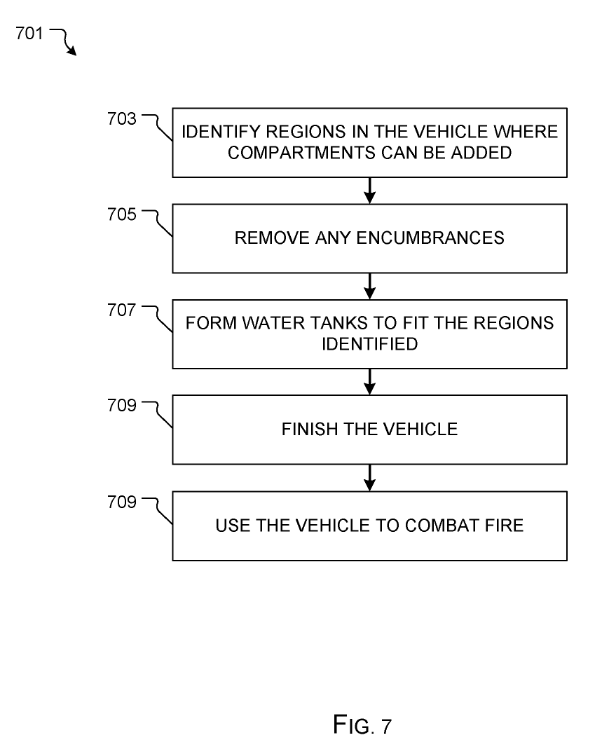

It is contemplated that the water tank could be of a continuous form while occupying locations in and out of the frame as depicted in FIG. 6. Embodiment 601 including a body 603 having an inner surface 605 that encloses a water tank 607. It will be understood that the top is removed for clarity. It will also be appreciated that the body 603 has cutouts 609 to accommodate other features of the system or alter the volume of the water tank 607.

Referring now to FIG. 7 the preferred method of manufacture of the system 201 is depicted. Method 701 includes identifying regions in the frame where compartments or weight can be added 703, removing any encumbrances 705, forming water tanks to fit in the regions identified 707, finishing the vehicle 709 and using the vehicle to combat fire 711.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. A stable wildland fire engine comprising:
a water tank attached to a support member in between a frame; and
a storage compartment to a support member in between the frame;
wherein the water tank and storage compartments enable a part or whole of the weight of what is stored is below the frame.

2. A method of manufacturing vehicles to combat wildfires, comprising:
identifying regions in the frame where compartments or weight can be added;
removing any encumbrances;
forming water tanks to fit in the regions identified;
finishing the vehicle; and
using the vehicle to combat fire.
